(19) United States
(12) Patent Application Publication
(10) Pub. No.: US 2011/0185919 A1
(43) Pub. Date: Aug. 4, 2011

(54) Modular pizza cart

(76) Inventor: Guillermo Julio Yglesias, San Jose, CA (US)

(21) Appl. No.: 12/658,206

(22) Filed: Feb. 3, 2010

(51) Int. Cl. A47J 37/00

(52) U.S. Cl. 99/443 R

(57) ABSTRACT

A modular pizza cart is disclosed. The modular pizza cart includes a housing, at least one oven disposed on a housing work area, and at least one refrigeration unit disposed within the housing, the at least one refrigeration unit sized and configured to receive thereinside a removable rack, the removable rack adapted to hold a plurality of trays upon which are disposed a plurality of partially baked and sliced pizzas.

### BACKGROUND OF THE INVENTION

1. Field of the Invention

The present invention relates generally to vending carts and more particularly to a modular pizza cart having an oven configured to bake a slice of pizza.

2. Background Art

Pizza is one of America's favorite foods accounting for $30 billion in yearly sales. Pizzerias represent 17% of all restaurants in the U.S. and pizza sales account for more than 10% of all foodservice sales. Notwithstanding the popularity of pizza, freshly baked pizza is primarily available from restaurants that are expensive to build and that are not located in high traffic areas such as shopping malls, airports, corporate campuses and schools.

Prior art attempts at providing pizza in such locations include mobile pizza carts that provide a warming oven for storing pre-baked pizzas. One such mobile pizza cart is available from American Restaurant Equipment Company and includes a dry oven made out of stainless steel that holds 20 cooked 16″ pizzas in cardboard at 180° F. The mobile pizza cart also includes a display case with tempered glass that is heated to 140° F.

Other solutions include providing a pizzeria on wheels. Examples of such pizzerias include the Pupatella Neapolitan Pizza Cart and the “Hot and Fresh” Pizza Pizza cart. These carts include a conventional restaurant pizza oven in which the pizzas are baked. Another pizzeria on wheels includes the SOLO Wood Fired Pizza Cart from Vengo 2000 Inc. This pizza cart has a wood-fired oven as disclosed in U.S. Pat. No. 6,199,549 to Yerkes entitled “Transportable Vending Cart with Wood-Fired Oven”.

Conventional pizza carts suffer the disadvantage of having large and expensive ovens whose operation requires great amounts of energy. This disadvantage creates a high barrier to entry into the pizza cart market. Additionally, the pizzas provided by these pizza carts tend to have soggy crusts as the pizzas are pre-baked and only kept hot or reheated.

There remains a need in the art for a pizza cart that is modular and has an oven sized and configured to bake a slice of pizza. There is a further need for a modular pizza cart that includes a refrigerator unit adapted to receive a rack upon which have been loaded a plurality of partially baked (par-baked) and sliced pizzas.

### SUMMARY OF THE INVENTION

The present invention provides a modular pizza cart that solves the problems associated with prior art pizza carts. The modular pizza cart comprises at least one oven sized and configured to heat a slice of pizza. Additionally, the modular pizza cart includes a refrigeration unit adapted to receive a rack insertable into the refrigeration unit and upon which a plurality of par-baked and sliced pizzas may be loaded.

In accordance with one aspect of the invention, a modular pizza cart includes a housing, at least one oven disposed on a housing work area, and at least one refrigeration unit disposed within the housing, the at least one refrigeration unit sized and configured to receive thereinside a removable rack, the removable rack adapted to hold a plurality of trays upon which are disposed a plurality of partially baked and sliced pizzas.

In accordance with another aspect of the invention, a modular pizza cart includes a housing, at least one oven disposed on a housing work area, the oven being operable to reach an internal temperature of between 450 and 550° F., and at least one refrigeration unit disposed within the housing, the at least one refrigeration unit sized and configured to receive thereinside a removable rack, the removable rack adapted to hold a plurality of trays upon shelf means, the plurality of trays having disposed thereon a plurality of partially baked and sliced pizzas.

In accordance with another aspect of the invention, the oven is sized and configured to receive at least one slice of pizza

In accordance with another aspect of the invention, the modular pizza cart is mobile.

In accordance with another aspect of the invention, the modular pizza cart is stationary.

In accordance with another aspect of the invention, the modular pizza cart comprises a storage compartment.

In accordance with another aspect of the invention, the modular pizza cart comprises a cash register.

In accordance with another aspect of the invention, the modular pizza cart comprises a display case.

In accordance with another aspect of the invention, the modular pizza cart comprises a sink.

In accordance with another aspect of the invention, the modular pizza cart comprises a water heater.

In accordance with another aspect of the invention, the modular pizza cart comprises a power source.

In accordance with another aspect of the invention, the modular pizza cart comprises a fuel source.

In accordance with another aspect of the invention, the modular pizza cart comprises a countertop work area.

In accordance with another aspect of the invention, the modular pizza cart comprises at least one working pizza refrigerator.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the arrangement of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and apparatus for carrying out the several purposes of the present invention. It is important, therefore, that the claims be regarded as including such equivalent methods and apparatus insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings wherein:

FIG. 1 is a perspective view of a modular pizza cart showing a rack disposed in a refrigeration unit in accordance with the invention;

FIG. 2 is a perspective view of the modular pizza cart of FIG. 1 showing the rack disposed outside of the refrigeration unit in accordance with the invention;

FIG. 3 is a perspective view of the rack in accordance with the invention;

FIG. 4 is a perspective view of the rack partially loaded with par-baked and sliced pizzas in accordance with the invention;

FIG. 5 is a perspective view of an alternative embodiment of the modular pizza cart showing two ovens and two refrigeration units in accordance with the invention; and

FIG. 6 is a perspective view of the modular pizza cart showing a slice of pizza disposed upon a tray in accordance with the invention.

### DETAILED DESCRIPTION OF THE INVENTION

The present invention provides a modular pizza cart comprising at least one oven sized and configured to heat at least one slice of pizza. Additionally, the modular pizza cart includes a refrigeration unit adapted to receive a removable rack insertable into the refrigeration unit and upon which a plurality of par-baked and sliced pizzas may be loaded.

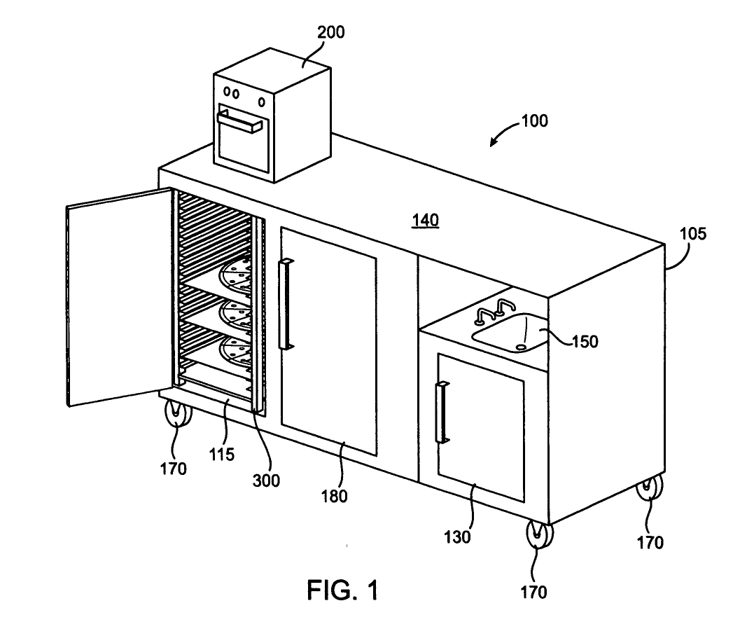

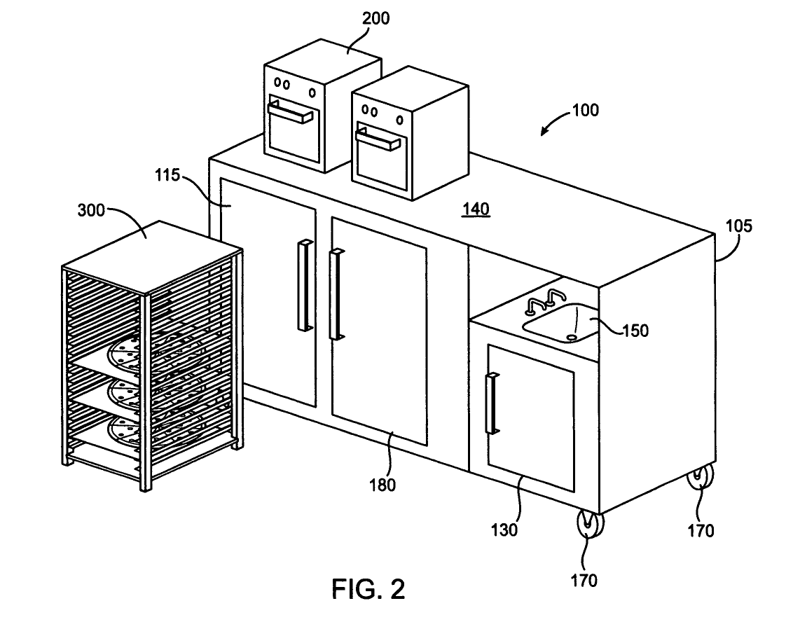

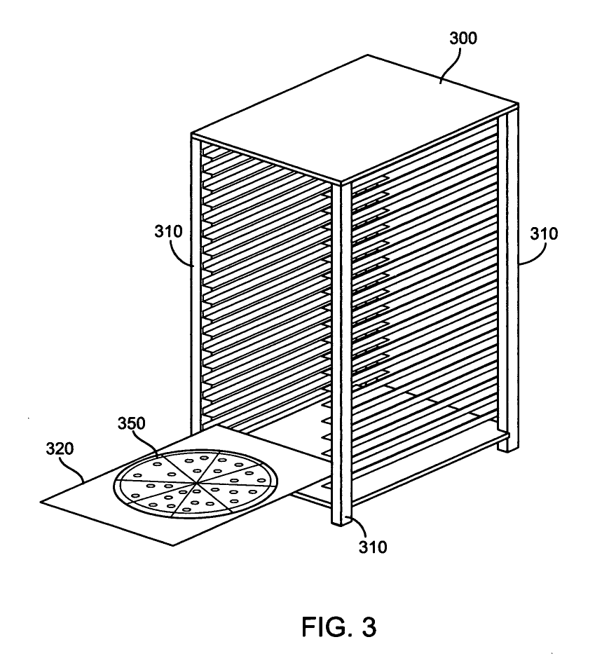

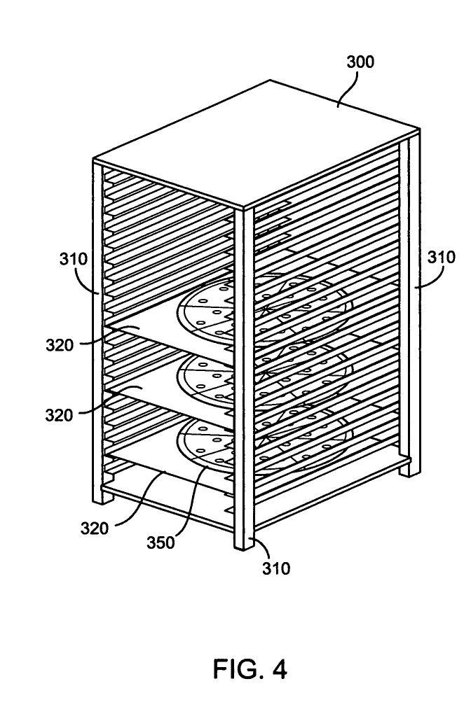

With reference to FIGS. 1 and 2, a preferred embodiment of a modular pizza cart generally designated 100 is shown. The modular pizza cart 100 includes a housing 105 adapted to accommodate a refrigeration unit 115 therein. A removable rack 300 (FIGS. 3 and 4) is sized and configured to be received in the interior portion of the refrigeration unit 115. Removable rack 300 is preferably formed of aluminum and includes supports 310 extending along sides thereof. Supports 310 have attached thereto shelf means adapted to receive up to 20 trays 320 upon which par-baked and sliced pizzas 350 are disposed. The par-baked pizzas 350 are preferably assembled, partially backed and loaded onto racks 300 at a production facility such that the racks 300 can be easily loaded into refrigeration units 115 to thereby reduce handling and increase productivity.

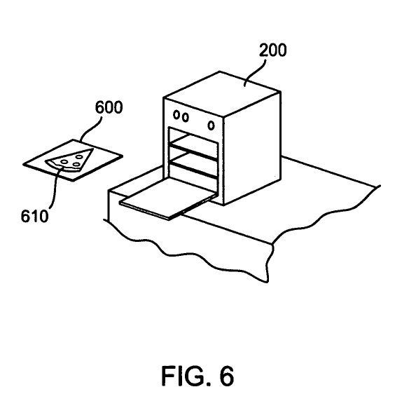

An oven 200 is preferably disposed atop a work area 140 of the housing 105 and is preferably 19 inches wide by 22 inches deep by 23 inches high and preferably has two levels. A tray 600 (FIG. 6) upon which a slice of par-baked pizza 610 is received is preferably 5 inches wide by 10 inches deep. The oven 200 is operable to reach an internal temperature of between 450 and 550° F. to thereby finish baking the slice of par-baked pizza 610. Preferably the slice of par-baked pizza 610 is baked for between 2 and 3 minutes in the oven 200. By baking par-baked slices of pizza 610 in the oven 200, the modular pizza cart 100 provides slices of pizza having crispy crusts in a small amount of baking time to thereby allow for the provision of a large amount of completely baked slices of pizza to the consuming public.

Housing 105 further accommodates a smaller working refrigerator 130. The working refrigerator 130 provides space for slices of par-baked pizza 610 that are ready to be loaded into the oven 200. The housing 105 may further include a storage compartment 180 for storing accessories including additional sodas, pizza boats, napkins, cheeses, peppers and cleaning supplies.

The modular pizza cart 100 further includes the work area 140 upon which is shown disposed the oven 200 and under which is shown a sink 150. Other conventional items (not shown) that may be included in the modular pizza cart 100 include a cash register and a display case disposed on the work area 140. Wheels 170 provide mobility to the modular pizza cart 100. Further conventional components (such as a heat source for the oven 200, an electrical energy source for the oven 200, water source, and cart handles) are not shown but are understood to form part of the modular pizza cart 100.

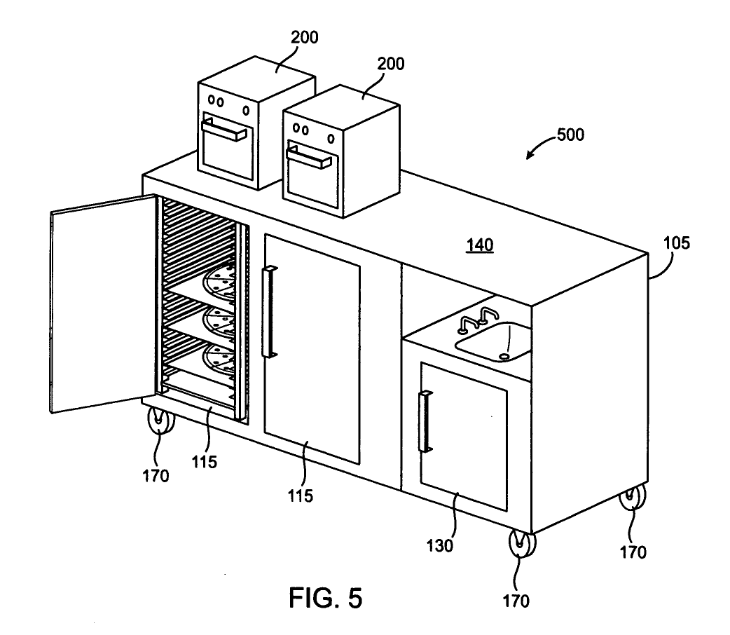

The modular pizza cart 100 has been described as having one refrigeration unit 115 and one small oven 200 but one skilled in the art will recognize that other numbers of refrigeration units 115 and ovens 200 are within the scope of the invention. More particularly, it is contemplated that for lower traffic areas, the modular pizza cart 100 may have one refrigeration unit 115 and one small oven 200 (as shown in FIG. 1) while areas of greater traffic may have additional refrigeration units 115 and ovens 200. For example, an alternative embodiment of the modular pizza cart generally designated 500 (FIG. 5) includes two ovens 200 and two refrigeration units 115. As exemplified by the modular pizza cart 100, the locations of the various components of my inventive modular pizza cart may be changed without departing from the scope and spirit of the invention.

The modular pizza cart in accordance with the invention provides a mobile or stationary pizza vending cart having at least one oven sized and configured to bake a slice of partially baked pizza. Additionally, the modular pizza cart includes a refrigeration unit adapted to receive a rack insertable into the refrigeration unit and upon which a plurality of partially baked and sliced pizzas may be loaded.

The foregoing description of the embodiments of the invention has been presented for the purposes of illustration and description. It is not intended to be exhaustive or to limit the invention to the precise form disclosed. Many modifications and variations are possible in light of the above teaching. For example, the numbers and locations of the various components of the modular pizza cart are dependent upon the application to which the modular pizza cart is put. It is intended that the scope of the invention be limited not by this detailed description, but rather by the claims appended hereto.

I claim:

1. A modular pizza cart comprising:
a housing;
at least one oven disposed on a housing work area; and
at least one refrigeration unit disposed within the housing, the at least one refrigeration unit sized and configured to receive thereinside a removable rack, the removable rack adapted to hold a plurality of trays upon which are disposed a plurality of partially baked and sliced pizzas.

2. The modular pizza cart of claim 1, wherein the oven is sized and configured to receive at least one slice of partially baked pizza.

3. The modular pizza cart of claim 2, wherein the at least one slice of partially baked pizza is receivable upon a tray sized and configured to be received in the oven.

4. The modular pizza cart of claim 1, wherein the oven is operable to reach an internal temperature of between 450 and 550° F.

5. The modular pizza cart of claim 1, wherein the at least one oven is powered from a fuel source.

6. The modular pizza cart of claim 1, wherein the at least one oven is powered from an electrical source.

7. The modular pizza cart of claim 1, further comprising a working refrigerator disposed within the housing.

8. The modular pizza cart of claim 1, further comprising a storage compartment disposed within the housing.

9. The modular pizza cart of claim 1, further comprising a sink disposed under the housing work area.

10. A modular pizza cart comprising:
a housing;
at least one oven disposed on a housing work area, the oven being operable to reach an internal temperature of between 450 and 550° F.; and
at least one refrigeration unit disposed within the housing, the at least one refrigeration unit sized and configured to receive thereinside a removable rack, the removable rack adapted to hold a plurality of trays upon shelf means, the plurality of trays having disposed thereon a plurality of partially baked and sliced pizzas.

11. The modular pizza cart of claim 10, wherein the oven is sized and configured to receive at least one slice of partially baked pizza.

12. The modular pizza cart of claim 11, wherein the at least one slice of partially baked pizza is receivable upon a tray sized and configured to be received in the oven.

13. The modular pizza cart of claim 10, wherein the at least one oven is powered from a fuel source.

14. The modular pizza cart of claim 10, wherein the at least one oven is powered by an electrical source.

15. The modular pizza cart of claim 10, further comprising a working refrigerator disposed within the housing.

16. The modular pizza cart of claim 10, further comprising a storage compartment disposed within the housing.

17. The modular pizza cart of claim 10, further comprising a sink disposed under the housing work area.
